(19) United States
(12) Patent Application Publication
(10) Pub. No.: US 2012/0001411 A1
(43) Pub. Date: Jan. 5, 2012

(54) Security Document Comprising At Least One Combined Image and A Revelation Means, and Associated Method

(76) Inventor: Henri Rosset, Le Pin (FR)

(21) Appl. No.: 13/141,565

(22) PCT Filed: Dec. 23, 2009
(86) PCT No.: PCT/IB2009/055934

§ 371 Date: Sep. 20, 2011

(30) Foreign Application Priority Data
Dec. 23, 2008 (FR) 08 59017

(51) Int. Cl. B42D 15/00

(52) U.S. Cl. 283/70; 283/85

(57) ABSTRACT

A security document (1) including a revealer raster (3) associated with a combined image (2) present on the document (1) and/or on another article, this combined image (2) comprising at least two interleaved images, at least one of the combined image (2) and the revealer raster (3) appearing in a zone of the document (1) that is at least partially transparent, the revealer raster (3), when superposed at least in part on the combined image (2) of the same document (1) or of the other article, serving to observe the interleaved images in succession by relative movement between the revealer raster (3) and the combined image (2), it being possible to superpose the revealer raster (3) and the combined image (2) by folding the document (1) and/or by superposing the document (1) on the other article.

### BACKGROUND

Methods relying on retinal persistence to enable movement to be reproduced are known in the prior art. For example, the phenakistoscope is known that uses a card disk pierced by slots on which movement is broken down as a sequence of still images, and a handle serves to hold it while it is rotating. Also known is the zeotrope that consists in a drum pierced by slots in its top half and housing inside, in its bottom half, a strip of drawings that break down a movement. When the drum is rotated while an observer is staring at its inside through the slots, the drawings become animated. Also known is the praxinoscope that operates on the same principle as the zeotrope and that includes a plurality of mirrors around its central axis in order to view the illusion of movement.

Methods of creating illusions of movement are also known as described in documents U.S. Pat. No. 5 901 484, U.S. Pat. No. 6 286 873, and U.S. 2005/0183300. Those methods make use of the principle of breaking down the movement so as to enable movement to be played back with a “raster”. The medium carries a plurality of fragmented images, e.g. corresponding to breaking down the movement of an animal or an article, and a transparent film carrying an array of parallel strokes of given thickness and spacing between the strokes is placed on the medium. Relative movement between the fragmented images and the array of parallel strokes serves to create the illusion of movement.

It is also known to superpose two elements by folding a document. Application WO 2006/029744 A1 describes in particular superposing two optical elements by folding a document so as to obtain optical effects that differ depending on the distance between said optical elements. Furthermore, application WO 02/17242 A1 describes folding a document to superpose a hologram and hidden information so as to reveal said hidden information. Finally, application U.S. 2006/0290136 A1 describes folding a document to superpose a coded image and a lens in order to decode said image.

### SUMMARY

In order to combat counterfeiting or falsifying security documents and in order to increase the level of security of such documents, it is known to incorporate various security elements therein enabling the document to be authenticated.

There exists a need to further strengthen security and methods of authenticating security documents, in particular in order to make it more difficult to counterfeit such documents.

The invention thus proposes specifically to make use of the principle of breaking down movement as described above so as to be able to authenticate security documents, e.g. by viewing broken-down movements so as to give rise to an illusion of movement.

In one of its aspects, the invention thus provides a security document including revealer means selected from a revealer raster and/or a lens array, associated with a combined image present on the document or on another article, in particular a similar document, the combined image including at least two interleaved images, at least one of the combined image and the revealer means appearing on a zone of the document that is at least partially transparent, and preferably completely transparent, the revealer means, when superposed at least in part on the combined image of the same document or of the other article, in particular a similar document, making it possible to observe the interleaved images in succession, with it being possible to superpose the revealer means and the combined image by folding the document and/or by superposing the document on the other article, in particular a similar document.

The term “associated” should be understood as meaning that the revealer means are advantageously adapted to enable the various interleaved images of the combined image to be viewed.

By way of example, the similar document may be similar in its function and/or its shape to the document of the invention. For example, both documents may be bank notes, e.g. having the same face value. The two documents may differ from each other solely in their serial numbers, for example.

The similar document may thus advantageously include revealer means and/or a combined image capable of being associated respectively with the combined image and/or the revealer means of the document of the invention.

By means of the invention, it is thus possible to benefit from a security document that presents a novel structure for authenticating the document that consists in playing back interleaved images, e.g. giving rise to the illusion of movement, by superposition and relative movement of a combined image and revealer means, in particular a revealer raster or a lens array, and/or changing the angle of observation of the superposed combined image and revealer means, in particular a lens array.

The relative movement of the combined image and the revealer means may enable the interleaved images to be observed in succession, in particular by imparting relative movement of the revealer means in a plane parallel to the plane containing the combined image.

Preferably, the combined image and the revealer means are superposed so as to be in contact.

Said relative movement may in particular be a movement in translation.

By means of the invention, with a security document that can be authenticated by relying on an effect of revealing interleaved images, e.g. creating a movement effect, it is possible to impart thereto an effect that the user finds amusing and/or attractive.

The interleaved images may be observed in succession in transmitted light, with the combined image and the revealer raster being placed between a light source and the observer, and/or they may be observed in reflected light, the observer looking at the combined image and the revealer raster as illuminated in reflection by a light source.

The combined image and the interleaved images it comprises may be raster images.

The combined image may correspond to breaking down a movement of a pattern, e.g. a text, alphanumeric signs, ideograms, an article, a person, and/or an animal. The interleaved images may present successive positions and/or successive movements of a pattern, e.g. an article, a person, and/or an animal.

The combined image may advantageously be obtained by superposing interleaved images each representing a movement of the pattern.

The interleaved images may represent information that is hidden and that is revealed in succession by relative movement, in particular relative movement in translation, of the revealer means over the combined image and/or by changing the angle of observation of the revealer means superposed on the combined image.

The combined image preferably conserves a recognizable design, in particular so as to constitute a first authentication element.

The revealer means may be a revealer raster and, by way of example, the interleaved images may be observed by moving the revealer means relative to the combined image, in particular in translation.

The revealer means may be a lens array and the interleaved images may also be observed by relative movement, in particular in translation, or by changing the angle of observation of the revealer means superposed on the combined image.

The revealer means may enable the human eye to view the different interleaved images one at a time, with the observer's brain serving for example to reconstitute movement or to observe hidden information.

The term “lens array” refers to an array of microlenses superposed on the combined image, itself made up of interleaved images.

Furthermore, the terms “raster image” and “revealer raster” in the meaning of the present invention should be understood broadly as covering all types of raster or pseudo-raster, involving juxtaposed pale and dark zones that are distinguishable from one another, the shapes of the pale and dark zones not being limited to any particular shape, but possibly being arbitrary.

For example, the combined image and/or the revealer means may comprise sets of points and/or optionally parallel lines of size and/or mutual spacing that vary or that are constant, such a set forming a succession of zones that are pale and dark, e.g. white and black.

In particular, when the combined image and/or the revealer means comprise respective sets of points, e.g. arranged in rows and/or columns, the interleaved images may be observed by movement in translation in at least two directions. These may comprise in particular a direction parallel to said rows and another direction parallel to said columns.

The combined image and/or the revealer means may in particular include a set of lines, preferably mutually parallel lines, of width and mutual spacing that are defined. In particular, the lines may have the same width and/or the same mutual spacing.

By way of example, the combined image and/or the revealer means may comprise a succession of lines that are dark and pale, e.g. black and white. The width of the dark lines of the combined images may be equal to the width of the pale lines of the revealer means, and vice versa, for example.

The revealer means may comprise opacifying bands with parallel edges, optionally edges that are not rectilinear. The presence of opacifying bands with non-rectilinear edges may make reproduction more difficult for a counterfeiter.

Preferably, the area, and in particular the length and/or the width and/or the long dimension of the revealer means may be greater than or equal to the area, and in particular the length and/or the width and/or the long dimension of the combined image. As a result, it is possible to view the entire reconstitution of the movement produced by relative movement between the combined image and the revealer means and/or by changing the angle of observation of the superposed revealer means and combined image.

The revealer means may be of any shape, e.g. circular, oval, star-shaped, polygonal, e.g. rectangular, square, hexagonal, pentagonal, lozenge-shaped, among others.

In a variant of the invention, two combined images of different dimensions are associated. The smaller combined image is in particular repeated, in particular in an array, in particular of rows and columns, so as to appear as a background on which the larger combined image is placed.

The associated revealer means are then constituted by first revealer means adapted to the larger combined image and second revealer means adapted to the smaller combined image.

The two different combined images may present similarities and/or may be complementary. In particular, they may be identical and/or symmetrical.

The security document may be folded along a mid-line of the document, preferably parallel to a side of the document, e.g. along a mid-line passing through the middle of the width or of the length of the document.

The combined image and/or the revealer means may appear in a window of the security document, the window being in particular at least partially transparent. Embodiments of security windows in security documents are described for example in the following documents: GB 1 552 853, which describes creating a window in particular by transparentizing, laser cutting, abrasion, or mechanical cutting; EP 0 229 645, which describes using an electrotype to create a window in one or both faces of two-ply paper; WO 2004/096482, which describes creating a window by laser cutting; CA 2 471 379, which describes creating a transparent window and associating it with a security element; and WO 2008/006983, which describes creating a transparent window in two-ply paper.

In another variant of the invention, the combined image and/or the revealer means may appear in a zone of the security document that presents reduced opaqueness. Such a zone of reduced opaqueness may correspond in particular to a zone of smaller thickness, to a zone that has been made transparent, or to a zone that includes at least one layer of a material of lesser opacity. The opacity of said zone of reduced opacity should in particular be sufficiently small to allow observation in transmission, and preferably sufficiently small to allow observation both in transmission and in reflection.

The combined image and/or the revealer means, in particular a revealer raster, may be applied to the security document by a printing method, e.g. an offset, copper plate, laser, photogravure, typography, or silk-raster printing method.

For example, the combined image and/or the revealer means may be printed, e.g. using inks that are optionally colored, visible to the naked eye, in ultraviolet (UV) and/or infrared (IR) light, opaque or luminescent, in particular fluorescent, thermochromic, photochromic, presenting an interference effect, in particular iridescent, or an optically variable effect depending on the angle of observation (goniochromatic), in particular including liquid crystals, that may be optionally metallic, and/or optionally magnetic, among others.

The combined image and/or the revealer means may also include metal coating and/or metal stripping, e.g. using aluminum.

Advantageously, metal coating and/or metal stripping may be used to prevent counterfeiting by printing.

In particular, metal coating and/or metal stripping is used with different colors, e.g. by means of aluminum and copper.

The combined image and/or the revealer means may also be printed using liquid crystals and may be carried on a zone of the security document that polarizes light, such that the combined image and/or the revealer means are visible only once the document has been folded in half.

In a variant of the invention, the combined image and/or the revealer raster is a watermark or a pseudo-watermark. The interleaved images are then preferably observed in succession in transmitted light.

Watermarks are produced by techniques that are well known in the papermaking field. Pseudo-watermarks reproduce the appearance of a watermark by presenting differences in opacity, and they may be obtained mechanically by applying pressure with or without applying heat, and/or chemically by applying a composition, e.g. a composition that locally increases the transparency of the paper by means of transparentizing substances. The density of the fiber material in the paler zones and in the darker zones of a pseudo-watermark may be uniform, unlike a conventional watermark.

The combined image, the interleaved images, and/or the revealer raster may be colored, in particular may be of different colors. In particular, the combined image and the revealer raster, or indeed the various interleaved images, may be of different colors.

The document may include a recto face and a verso face and it may be provided with two at least partially transparent windows respectively carrying the combined image and the revealer raster. The combined image and/or the revealer raster may be metal coated. In particular, the combined image may be formed by coating with a first metal, e.g. aluminum, on the recto face, and by coating with a second metal, e.g. copper, in a pattern identical thereto and in register therewith, on the verso face of the document. Conversely, the revealer raster may be formed by coating with a first metal, e.g. copper, on the recto face, and by coating with a second metal, e.g. aluminum in a pattern identical thereto and in register therewith, on the verso face of the document. As a result, when the document is folded in half, there can be observed on one side of the document the recto face of the combined image and the verso face of the revealer raster, both made using the same metal, e.g. aluminum. Conversely, on the other side of the document, it is possible to observe the verso face of the combined image and the recto face of the revealer raster, both made using the same metal, e.g. copper.

The combined image and/or the revealer means may be carried by a patch and/or a foil appearing on the security document.

The patch and/or the foil may include metal coating and/or metal stripping, e.g. using aluminum, or any type of printing.

The patch and/or the foil may include holographic and/or liquid crystal printing.

The combined image and/or the revealer means may also be carried by a security strip that is incorporated on the surface of, embedded in, or located in one or more windows in the security document.

The document may also include a security strip presenting alternating combined images and revealer means.

Advantageously, the presence of a succession of combined images and/or of revealer means on the security strip may make it possible to avoid introducing the security strip in an exact position while the security document is being formed.

The security document may also include two security strips, one carrying at least one combined image and the other carrying at least one revealer means.

The security strip(s) may present width that is sufficient to enable the combined image and/or the revealer means to appear therein in full.

The width of the security strip(s) may for example lie in the range 3 millimeters (mm) to 20 mm, and preferably in the range 4 mm to 8 mm, preferably being equal to 4 mm. The security document may thus include the following combinations between combined images and revealer means:

at least one combined image, or one revealer means, carried by a window of the document, and the associated revealer means, or respectively the combined image, being in the form of printing, metal coating, and/or metal stripping carried elsewhere on the security document;

at least one combined image, or revealer means, carried by a window of the security document, and the associated revealer means, or combined image, appearing on a patch or a foil of the security document;

at least one combined image, or revealer means, carried by a window of the security document, and the associating revealer means, or combined image, appearing on a security strip of the security document;

an alternation of combined images and revealer means carried by a security strip incorporated in the security document;

a security strip carrying a plurality of combined images, or of revealer means, and the associated revealer means, or combined images, appearing as printing on the security document; or

at least two security strips, one carrying one or more combined images and the other carrying one or more associated revealer means, this list not being limiting.

The revealer means and/or the combined image advantageously appear on a zone of the document that is at least partially transparent, in particular the revealer means and/or the combined image may at least be partially transparent.

The at least partially transparent zone may correspond to an optional through recess in the document having the revealer means and in particular a lens array and/or a revealer raster, and/or the combined image placed therein.

By way of example, the zone may be constituted by a translucent tracing paper.

The zone may also be constituted by a polymer layer, e.g. comprising polyethylene (PE), polyvinyl chloride (PVC), polyethylene terephthalate (PET), polycarbonate (PC), polyester carbonate (PEC), polyethylene terephthalate glycol (PETG), acrylonitrile butadiene styrene (ABS), or a light-collecting film, e.g. of the “waveguide” type, e.g. a luminescent film based on polycarbonate as sold by the supplier Bayer under the name Lisa®.

When using a waveguide film, the combined image or the revealer raster is obtained in particular by laser etching.

The zone may also be transparentized by applying a generally fatty composition that makes the zone transparent on a permanent basis, such as for example a composition of oil and transparent mineral material as described in patent U.S. Pat. no. 2,021,141, or such as for example a composition in the form of a wax combined with a solvent, as described in patent U.S. Pat. No. 1,479,437.

It is also possible to make the zone transparent by locally applying a wax by hot transfer, as described in patent U.S. Pat. No. 5,118,526.

For the zone, it is possible to use a fiber layer including a hot-melt material, e.g. polyethylene as described in patent EP 0 203 499, so that the transparency thereof can be made to vary under local action of heat.

In a particular embodiment of the invention, the combined image may also be represented on another element of the security document, thereby providing additional security. Said other element of the security document may in particular be a watermark, a print, a patch, or a foil.

The security document, and the elements it includes such as for example a security strip, a patch, and/or a foil may include one or more security elements as defined below.

Among security elements, some are detectable by eye, in daylight or in artificial light, without using any particular appliance. By way of example, these security elements comprise colored fibers or flakes, and strips that are printed or metal plated in full or in part. Such security elements are said to be first level elements.

Other types of security element are detectable only with the help of an appliance of a relatively simple type, such as a lamp emitting in the ultraviolet (UV) or the infrared (IR). By way of example, these security elements comprise fibers, flakes, bands, strips, or particles. These security elements may be optionally visible to the naked eye, e.g. being luminescent under lighting from a Wood's lamp that emits at a wavelength of 365 nanometers (nm). These security elements are said to be second level elements.

Still other types of security element require a detector appliance that is more sophisticated in order to be detected. By way of example, these security elements are capable of generating a specific signal when subjected, possibly simultaneously, to one or more external excitation sources. Where appropriate, automatic detection of the signal enables the document to be authenticated. By way of example, these security elements comprise tracers in the form of active materials, particles or fibers, capable of generating a specific signal when the tracers are subjected to optronic, electrical, magnetic, or electromagnetic excitation. These security elements are said to be third level elements.

The security elements present within the security document and the elements it includes may present security characteristics of the first, second, or third level.

By way of example, the security document may comprise payment means, such as a bank note, a check, or a meal ticket, an identity document such as an identity card or a visa or a passport or a driver's license, a lottery ticket, a transport ticket, or indeed a ticket for entry to a cultural or sporting event.

In another of its aspects, the invention also provides a method of authenticating a security document as defined above, wherein the revealer means is superposed at least in part on the combined image in order to enable the interleaved images to be observed in succession, and a conclusion is drawn about the authenticity of the document, it being possible for the revealer means and the combined image to be superposed by folding the document and/or by superposing the document on another article, in particular a similar document.

The revealer means may be a revealer raster and the interleaved images may be observed by moving the revealer means relative to the combined image, in particular in translation.

The revealer means may be a lens array and the interleaved images may be observed by relative movement, in particular in translation, or by changing the angle of observation of the revealer means superposed on the combined image.

The invention can be better understood on reading the following description of non-limiting embodiments thereof and on examining the diagrammatic and fragmentary figures of the drawings, in which:

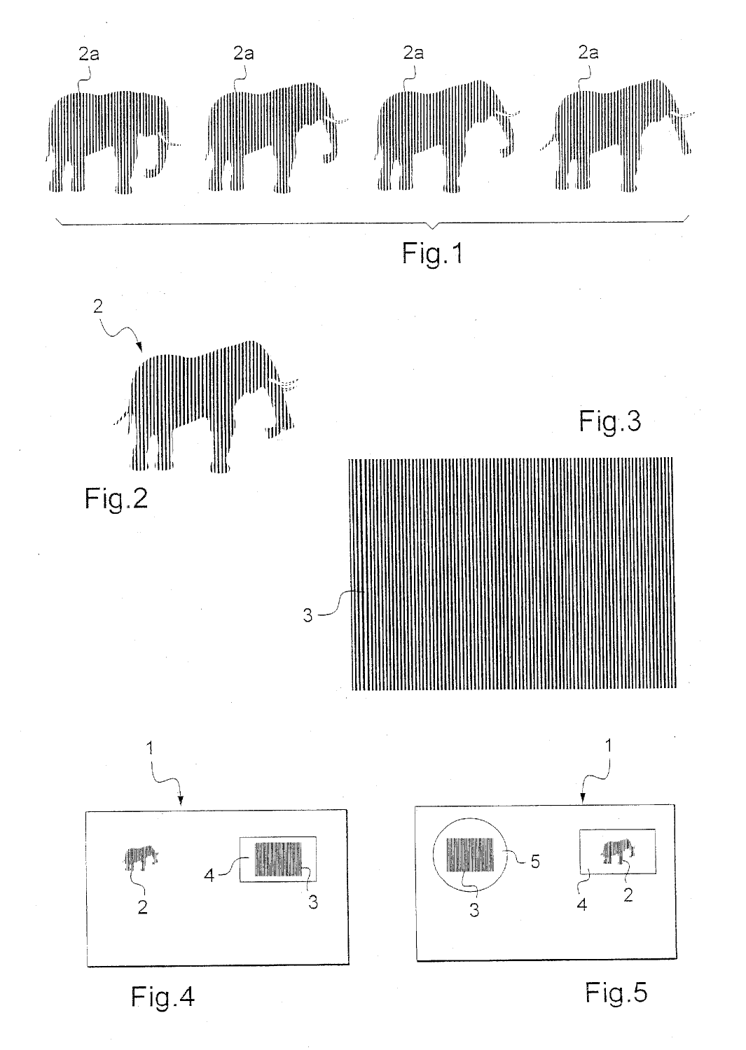

FIG. 1 shows a series of interleaved images serving to create a combined image of a document of the invention;

FIG. 2 shows a combined image of a document of the invention as obtained from the series of interleaved images of FIG. 1;

FIG. 3 shows an example of revealer means of a security document of the invention suitable for associating with the combined image of FIG. 2;

FIGS. 4 to 6 show embodiments of a security document of the invention, with the combined image or the revealer means being carried by a window of the document;

FIGS. 7 to 11 show other embodiments of a security document of the invention, the combined image and/or the revealer means being carried by at least one safety strip or a foil;

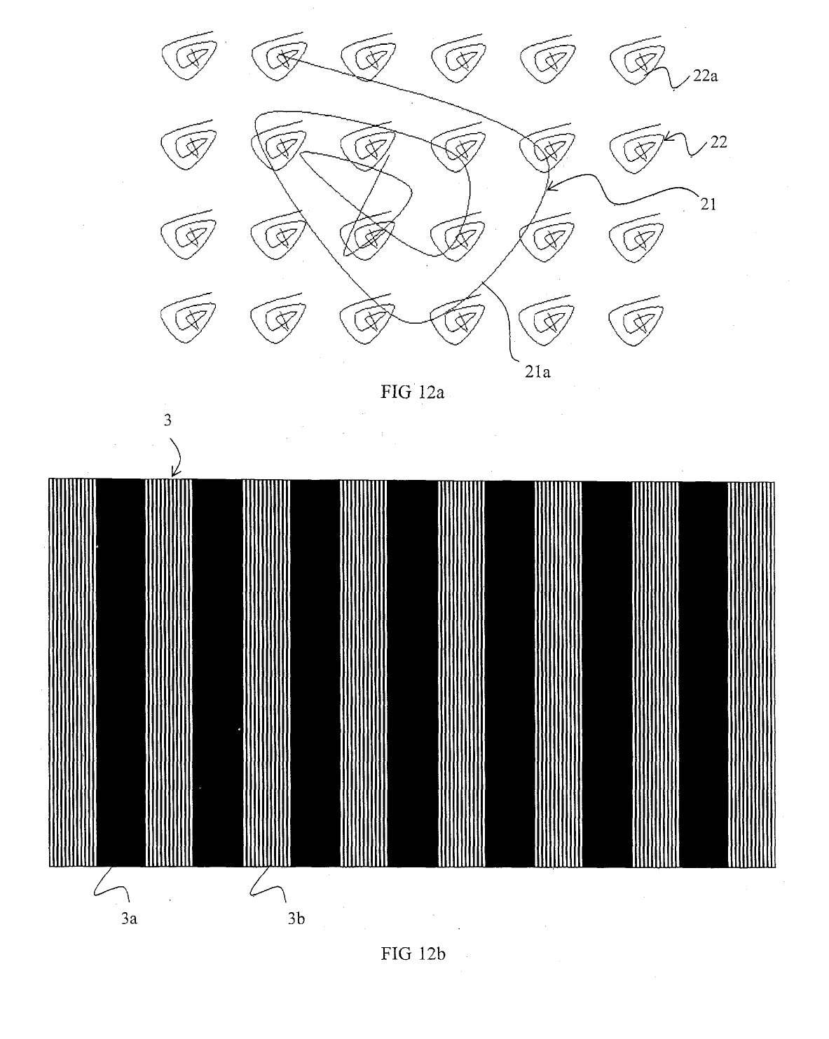

FIG. 12a shows an example of two different combined images of a document of the invention;

FIG. 12b shows an example of revealer means of a document of the invention suitable for associating with the combined images of FIG. 12a;

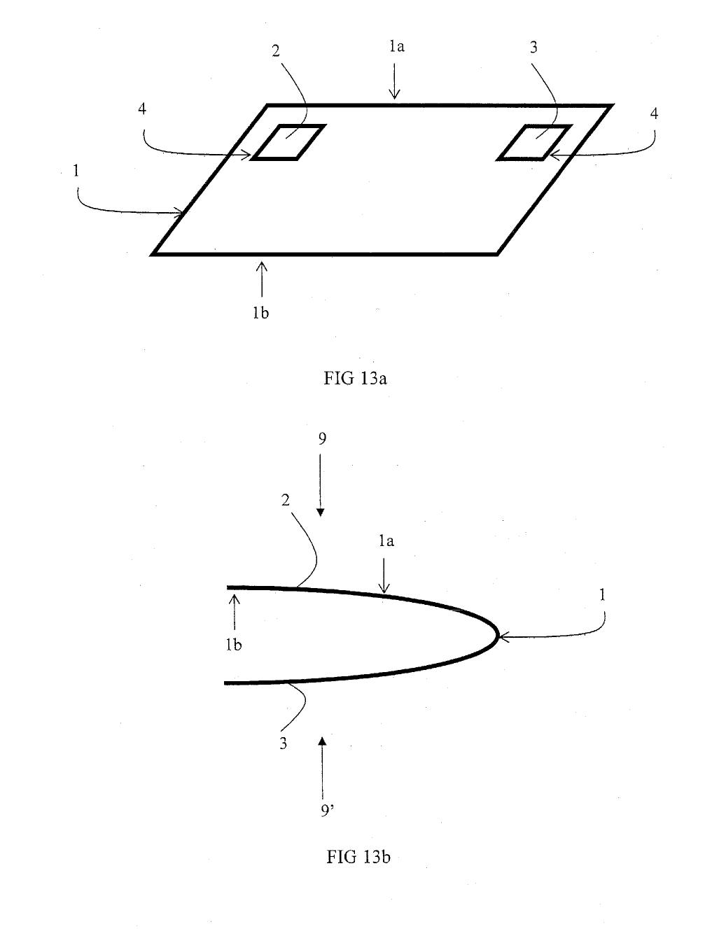

FIGS. 13a and 13b show another example of a document of the invention; and

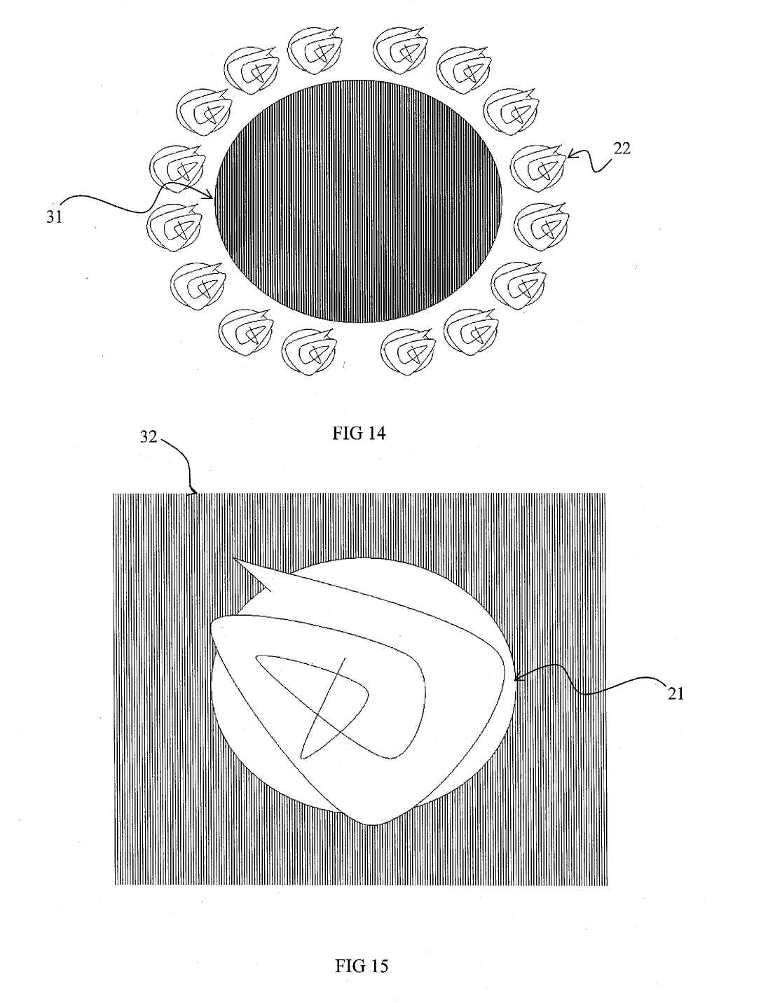

FIGS. 14 and 15 show patterns that may be associated, each of these patterns comprising both revealer means and a combined image.

FIG. 1 shows a series of interleaved images 2a suitable for creating a combined image 2 that, in this example, represents a pattern in the form of an elephant.

By way of example, the interleaved images 2a correspond to four different positions of the elephant, thus making it possible to break down a movement of the elephant.

Each interleaved image 2a comprises a set of parallel lines that are spaced apart in optionally regular manner and that present varying widths.

FIG. 2 shows the combined image 2 obtained from the series of interleaved images 2a of FIG. 1.

The images 2a are superposed on one another so as to form a combined pattern corresponding to the combined image 2.

FIG. 3 shows an example of revealer means 3 in the form of a revealer raster that may be associated with the combined image 2 of FIG. 2.

By way of example, the revealer means 3 are rectangular in shape and comprise a set of parallel lines spaced apart in optionally regular manner and having varying widths.

The revealer means 3 present an area, a length, and a width that are greater than those of the combined image 2, thus making it easier to view all of the movements of the elephant during relative movement between the combined image 2 and the revealer means 3.

In this example, the combined image 2 and the revealer means 3 comprise sets of lines that alternate between being dark and pale, in particular black and white, however they could be provided in some other way. For example, the lines could be colored and they could be different for the combined image 2 and for the revealer means 3.

The revealer means 3 may also comprise a lens array, e.g. comprising a translucent or transparent polymer film. The lens array could in particular be micro-embossed or printed.

FIGS. 4 to 6 show embodiments of a security document 1 of the invention comprising a combined image 2 in accordance with that shown in FIG. 2 and revealer means 3 in accordance with that shown in FIG. 3.

In FIG. 4, the document 1 has a window 4, which window is preferably at least partially transparent, and contains the revealer means 3. The document 1 also includes a combined image 2 carried by the document 1, e.g. printed thereon, in particular by copper plate printing, or metal coating, and/or metal stripping. The zone on which the combined image 2 appears may also be at least partially transparent.

In FIG. 5, the security document 1 has a window 4, which window is preferably at least partially transparent and in which a combined image 2 appears. The document 1 also includes a patch 5, e.g. including holographic printing, and in which the revealer means 3 appear. The patch 5 may also be at least partially transparent.

The patch 5 may comprise metal coating and/or metal stripping, e.g. using aluminum, and the revealer means 3 may comprise holographic printing and/or metal coating and/or metal stripping.

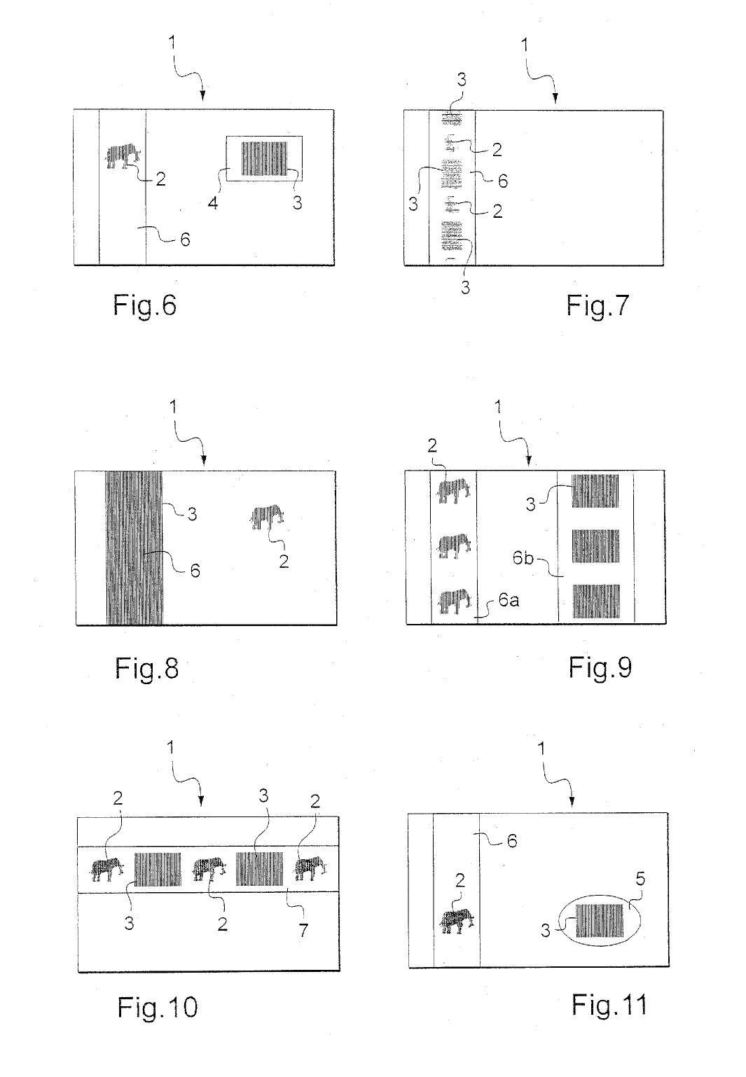

In FIG. 6, the document 1 has a window 4, which window is preferably at least partially transparent and has the revealer means 3 appearing therein. The document 1 also includes a security strip 6 on which the combined image 2 appears. The security strip 6 may also be at least partially transparent or include a zone that is partially transparent in register with the combined image 2.

FIGS. 7 to 11 show other examples of a security document 1 of the invention including a combined image 2 and revealer means 3 in accordance with those shown in FIGS. 2 and 3, the combined image 2 and/or the revealer means 3 being carried by at least one security strip or foil.

In FIG. 7, the document 1 has a security strip 6 of sufficient width to have alternating combined images 2 and revealer means 3 appearing therein. Advantageously, the security strip 6 is at least partially transparent or presents one or more zones that are at least partially transparent in register with the combined images 2 and/or the revealer means 3.

In FIG. 8, the document 1 includes a security strip 6 on which the revealer means 3 appear. The document 1 also includes a combined image 2, e.g. in the form of a copper plate print on the document 1.

The security strip 6 may be at least partially transparent or may present a zone that is at least partially transparent. The document 1 may also include a zone that is at least partially transparent in register with the combined image 2.

In FIG. 9, the document 1 has two security strips 6a and 6b. The security strip 6a has three combined images 2 and the security strip 6b has three revealer means 3.

The security strip 6a and/or the security strip 6b may be at least partially transparent or include at least one zone that is at least partially transparent, in particular in register with a combined image 2 or with revealer means 3.

In FIG. 10, the document 1 includes a foil 7 on which alternating combined images 2 and revealer means 3 appear.

The foil 7 may be at least partially transparent or may include at least one zone that is at least partially transparent in register with a combined image 2 and/or revealer means 3.

In FIG. 11, the document 1 includes a security strip 6 having a combined image 2 appearing thereon. The document 1 also includes a patch 5 that may include optionally holographic metal coating, with revealer means 3 appearing thereon.

The security strip 6 may be at least partially transparent or may include a zone that is at least partially transparent in register with the combined image 2.

The patch 5 may also be at least partially transparent, in particular in register with the revealer means 3.

In all of the above-described examples, the combined images 2 and the revealer means 3 may be interchanged.

The at least partially transparent zones may be situated in register with the combined images 2 or with the revealer means 3, or with both of them.

The security strip(s) 6, 6a, and 6b may be incorporated in the security document 1 in conventional manner, e.g. on its surface, embedded in its material, or in one or more windows.

The document 1 can be authenticated by folding the document 1 lengthwise or widthwise so as to superpose the combined images 2 and the revealer means 3 at least in part, and then by moving them relative to one another, e.g. so as to see the illusion of a moving elephant, and/or by modifying the angle of observation of the superposed combined images 2 and revealer means 3.

In a variant, it is also possible to superpose at least the document (1) with another similar document as described above.

In FIG. 12a, there can be seen diagrammatically two different combined images (21) and (22), the second combined image (22) possibly being an image that is symmetrical relative to the first combined image (21). The second combined image (22) has also been reduced in size and replicated so as to obtain an array of combined images (22) organized in rows and columns.

FIG. 12b shows the revealer raster (3) for revealing the interleaved images (21a) and (22a) shown diagrammatically in FIG. 12a. This revealer raster (3) is constituted by combining two individual rasters (3a) and (3b) serving respectively to observe the interleaved images (21a) and (22a).

FIG. 13a shows a document (1) having a recto face (1a) and a verso face (1b). The document (1) is provided with transparent windows (4) respectively carrying a metal-coated combined image (2) and a metal-coated revealer raster (3).

The combined image (2) is formed by an aluminum, first metal coating on the recto face (1a), and by a copper, second metal coating that is identical to the first and in register therewith, on the verso face (1b).

Conversely, said revealer raster (3) is formed by a copper, first metal coating on the recto face (1a) and by an aluminum, second metal stripping that is identical to the first and in register therewith, on the verso face (1b).

As a result, when the document (1) is folded as shown in FIG. 13b, and when looking along arrow (9), there are observed the aluminum recto face (1a) of the combined image (2) and the aluminum verso face (1b) of the revealer raster (3). Conversely, when looking along arrow (9′), there are observed the copper verso face (1b) of the combined image (2) and the copper recto face (1a) of the revealer raster (3).

FIG. 14 shows diagrammatically a combined image 22 arranged as an array of combined images 22 around a revealer raster 31.

FIG. 15 is a diagram showing a combined image 21 surrounded by a revealer raster 32.

One of the patterns shown in FIGS. 14 and 15 may be disposed on one document, and the other one may be disposed on the same document, or on a similar document, or on some other object.

In a variant, the array of combined images 22 constitutes two bands having the revealer raster 31 arranged as a band between them. The combined image 21 is then repeated along a band, placed in the center between two bands constituting the revealer raster 32. This variant and the repetition of the combined images and/or of the revealer raster in a band makes it possible in particular to facilitate positioning by eliminating orientation. Thus, for example when inserting a security strip in a sheet of paper that is being formed, there is no need for it to be positioned accurately in the transverse direction and it is only necessary for it to be positioned accurately in the travel direction.

The expression “comprising a” is synonymous with “comprising at least one”.

1-25. (canceled)

26. A security document comprising:
a revealer raster associated with a combined image present on the document and/or on another article, the combined image comprising at least two interleaved images,
wherein at least one of the combined image and the revealer raster appears in a zone of the document that is at least partially transparent,
wherein the revealer raster, when superposed at least in part on the combined image of the document or of another article, is configured to permit observation of the interleaved images in succession by relative movement between the revealer raster and the combined image,
wherein the revealer raster and the combined image are configured to be superposed by folding the document and/or by superposing the document on the other article.

27. A security document comprising:
a revealer raster associated with a combined image present on the document and/or on a similar document, the combined image comprising at least two interleaved images,
wherein at least one of the combined image and the revealer raster appears in a zone of the document that is at least partially transparent,
wherein the revealer raster, when superposed at least in part on the combined image of the document or of the similar document, is configured to permit observation of the interleaved images in succession by relative movement between the revealer raster and the combined image,
wherein the revealer raster and the combined image are configured to be superposed by folding the document and/or by superposing the document on the similar document.

28. The security according to claim 26, wherein the revealer raster and the combined image are configured to be superposed by folding the document.

29. The security according to claim 26, wherein the revealer raster and the combined image are configured to be superposed by superposing the document with the other article.

30. The security according to claim 26, wherein the area of the revealer raster is larger than or equal to the area of the combined image.

31. The security according to claim 26, wherein the combined image corresponds to breaking down the movement of a text, of alphanumeric signs, of ideograms, of an article, of a person, and/or of an animal.

32. The security according to claim 26, wherein the combined image and/or the revealer raster appears in a window of the security document.

33. The security document according to claim 26, wherein the window is at least partially transparent.

34. The security document according to claim 26, wherein the combined image and/or the revealer raster is applied to the security document by a printing method, offset, copper plate, laser, photogravure, typography, or silk-raster printing.

35. The security document according to claim 34, wherein the combined image and/or the revealer raster is printed with inks that are colored, visible to the naked eye under ultraviolet (UV) and/or infrared (IR) light, opaque, fluorescent, translucent, and/or transparent.

36. The security document according to claim 26, wherein the combined image and/or the revealer raster comprises metal coating and/or metal stripping.

37. The security according to claim 26, wherein the combined image and/or the revealer raster is printed with liquid crystals and is carried on a zone of the document that polarizes light such that the combined image and/or the revealer raster are visible only when the document is folded in half.

38. The security document according to claim 26, wherein the combined image and/or the revealer raster is carried by a patch and/or a foil appearing on the security document.

39. The security document according to claim 26, wherein the combined image and/or the revealer raster is carried by a security strip incorporated on the surface of, embedded in, or located in one or more windows in the document.

40. The security document according to claim 39, wherein the security strip presents alternating combined images and revealer rasters.

41. The security document according to claim 39, further comprising an additional security strip, one of the security strips carrying at least one combined image and the other security strip carrying at least one revealer raster.

42. The security document according to claim 39, wherein the width of the security strip ranges from 3 mm to 20 mm.

43. The security document according to claim 26, wherein the combined image is carried by a window of the document and the revealer raster comprises printing, metal coating, and/or metal stripping carried elsewhere on the document, or vice versa.)

44. The security document according to claim 26, wherein the combined image is carried by a window of the document, and the revealer raster appears on a patch or a foil of the document.

45. The security document according to claim 26, wherein the combined image is carried by a window of the document and the revealer raster appears on a security strip of the document.

46. The security document according to claim 26, wherein the combined image is made by laser etching a waveguide film.

47. The security document according to claim 26, wherein the revealer raster comprises a waveguide film and a revealer raster made by laser etching.

48. A method of authenticating the security of document of claim 1, the method comprising:
superposing at least in part the revealer raster of the security document of claim 1 on the combined image to enable observation of the interleaved images in succession by relative movement between the revealer raster and the combined image;
wherein the superposing comprises folding the security document and/or superposing the security document on another article.

49. The method according to claim 48, wherein the superposing comprises folding the document to superpose the revealer raster and the combined image at least in part.

50. The method according to claim 48, wherein the superposing comprises superposing the document on the other article.
